(19) United States
(12) Patent Application Publication
(10) Pub. No.: US 2015/0373469 A1
(43) Pub. Date: Dec. 24, 2015

(54) OPEN TYPE SPEAKER LEAK TEST SYSTEM AND METHOD

(71) Applicant: Primax Electronics Ltd., Neihu (TW)

(72) Inventor: YUNG-TAI PAN, Neihu (TW)

(21) Appl. No.: 14/478,771

(22) Filed: Sep. 5, 2014

(30) Foreign Application Priority Data
Jun. 20, 2014 (TW) 103121409

(51) Int. Cl. H04R 29/00

(52) U.S. Cl. CPC H04R 29/001

(57) ABSTRACT

An open-type speaker leak test system and an open-type speaker leak test method are provided for testing whether an open-type speaker has a leak. The open-type speaker includes an enclosure with an opening. The open-type speaker leak test system includes a sealing element, a vacuum generator, a first communication tube, and a pressure measuring module. The sealing element is locked into the opening. A negative pressure value of the enclosure is generated by the vacuum generator. The first communication tube is penetrated through the sealing element and in communication with the open-type speaker and the vacuum generator. An equilibrium pressure value of the enclosure is measured by the pressure measuring module. If the equilibrium pressure value is lower than a default negative pressure value, the open-type speaker has the leak. Consequently, the misjudgment is reduced, and the testing efficiency is enhanced.

### FIELD OF THE INVENTION

The present invention relates to a speaker leak test system and a speaker leak test method, and more particularly to an open-type speaker leak test system and an open-type speaker leak test method.

### BACKGROUND OF THE INVENTION

With the prevalence of various types of audio and video entertainments, it is important to play audio files of electronic devices (e.g. stereo devices, computers, television or mobile phones). Since speakers are able to convert electronic signals into sound waves, speakers become important peripheral electronic devices in modern lives. According to the structures of the sound boxes (also referred as enclosures), speakers are usually classified into close-type speakers and open-type speakers. In the open-type speaker, a speaker unit is placed within an enclosure with an opening. When the sound wave generated by the speaker unit is radiated backwardly to a backside plate of the enclosure, the sound wave is reflected by the backside plate and transmitted to the opening of the enclosure through a calculated path. Under this circumstance, the phase of the backwardly-radiated sound wave is adjusted to be identical to the phase of the forwardly-radiated sound wave from the speaker unit. Since the phase of the backwardly-radiated sound wave is identical to the phase of the forwardly-radiated sound wave of the speaker unit, the backwardly-radiated sound wave and the forwardly-radiated sound wave are superimposed with each other to result in constructive interference. Under this circumstance, the low-frequency radiation intensity is increased, and the performance of the speaker is enhanced.

In case that the enclosure of the open-type speaker has a leak, the sound wave may irregularly leak out through the leak. Under this circumstance, noise is possibly generated, and the sound quality of the open-type speaker is deteriorated. For maintaining the quality of the open-type speaker, it is necessary to test the open-type speaker before the open-type speaker leaves the factory.

Conventionally, some methods for testing whether the open-type speaker has a leak were disclosed. For example, an open-type speaker generates a low-pitched sound so as to produce an air pressure, and an inspector listens to the surface of the open-type speaker through a stethoscope. By detecting whether there in an airflow sound of the leak air, the inspector may judge whether the open-type speaker has a leak. However, the method of judging whether the open-type speaker has a leak according to the airflow sound takes a long testing time period. Moreover, since the judgment of the airflow sound is readily affected by human factors, the possibility of causing misjudgment is increased.

For increasing the testing efficiency and accuracy of testing open-type speakers, there is a need of providing an open-type speaker leak test system and an open-type speaker leak test method in order to solve the above drawbacks.

### SUMMARY OF THE INVENTION

An object of the present invention provides an open-type speaker leak test system and an open-type speaker leak test method for testing an open-type speaker more efficiently and accurately.

In accordance with an aspect of the present invention, there is provided an open-type speaker leak test system for testing whether an open-type speaker has a leak. The open-type speaker includes an enclosure with an opening. The open-type speaker leak test system includes a sealing element, a vacuum generator, a first communication tube, and a pressure measuring module. When the sealing element is locked into the opening, the opening is sealed. A negative pressure value of the enclosure is generated by the vacuum generator. The first communication tube is in communication with the open-type speaker and the vacuum generator. A first end of the first communication tube is penetrated through the sealing element and inserted into the enclosure of the open-type speaker. A second end of the first communication tube is connected with the vacuum generator. An equilibrium pressure value of the enclosure of the open-type speaker is measured by the pressure measuring module. According to a result of comparing the equilibrium pressure value of the open-type speaker with a default negative pressure value, the open-type speaker leak test system judges whether the open-type speaker has the leak, wherein the default negative pressure value is the negative pressure value generated by the vacuum generator when a qualified enclosure is tested.

In accordance with another aspect of the present invention, there is provided an open-type speaker leak test method for testing whether an open-type speaker has a leak. The open-type speaker includes an enclosure with an opening. The open-type speaker leak test includes the following steps. Firstly, the opening of the open-type speaker is sealed. Then, a vacuum generator and a pressure measuring module are in communication with an inner space of the enclosure of the open-type speaker. The vacuum generator is enabled, so that a negative pressure value of the enclosure is generated. Then, an air pressure in the vacuum generator and the enclosure of the open-type speaker reaches an equilibrium state. Then, an equilibrium pressure value of the enclosure of the open-type speaker is measured. Then, a judging step is performed to judge whether the open-type speaker has the leak according to a result of comparing the equilibrium pressure value of the open-type speaker with a default negative pressure value. The default negative pressure value is the negative pressure value generated by the vacuum generator when a qualified enclosure is tested.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating an open-type speaker according to an embodiment of the present invention;

FIG. 2 is a schematic cross-sectional view illustrating the open-type speaker according to the embodiment of the present invention;

FIG. 3 schematically illustrates the architecture of an open-type speaker leak test system according to an embodiment of the present invention;

FIG. 4 schematically illustrates the flowchart of an open-type speaker leak test method according to an embodiment of the present invention; and

FIG. 5 schematically illustrates the architecture of an open-type speaker leak test system according to another embodiment of the present invention.

### DETAILED DESCRIPTION OF THE PREFERRED EMBODIMENT

In this context, the enclosure (or sound box) of the open-type speaker has an opening. For example, the enclosure used in the open-type speaker of the present invention includes but is not limited to a bass reflex enclosure, a labyrinth enclosure or a horn type enclosure. In the following embodiments, the open-type speaker with the bass reflex enclosure will be illustrated as an example.

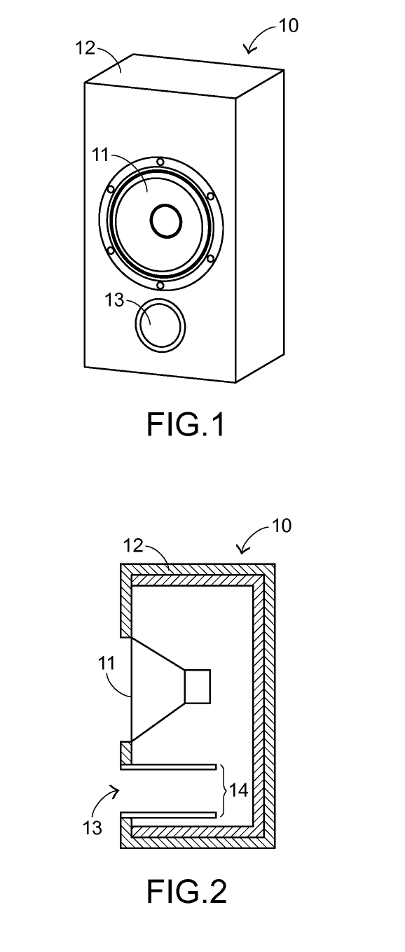

FIG. 1 is a schematic perspective view illustrating an open-type speaker according to an embodiment of the present invention. FIG. 2 is a schematic cross-sectional view illustrating the open-type speaker according to the embodiment of the present invention. As shown in FIGS. 1 and 2, the open-type speaker 10 comprises a speaker unit 11, an enclosure 12, an opening 13, and a sound guide tube 14. The speaker unit 11 is embedded in the enclosure 12. The opening 13 is formed in a surface of the enclosure 12. The sound guide tube 14 is disposed within the enclosure 12. An end of the sound guide tube 14 is connected with the opening 13. The functions of the opening 13 and the sound guide tube 14 will be illustrated as follows.

When the speaker unit 11 vibrates to generate sound waves, the sound waves may be radiated forwardly toward the front side of the speaker unit 11 and radiated backwardly toward the rear side of the speaker unit 11. The sound wave radiated forwardly toward the front side of the speaker unit 11 is referred as the forwardly-radiated sound wave; and the sound wave radiated backwardly toward the rear side of the speaker unit 11 is referred as the backwardly-radiated sound wave. Generally, the human ear is not very sensitive to the low-frequency sound wave. If the backwardly-radiated sound wave is guided to the outside of the enclosure 12, the low-frequency sound wave is increased. However, the phase of the forwardly-radiated sound wave and the backwardly-radiated sound wave is opposite. If the backwardly-radiated sound wave is directly outputted from the enclosure 12 without being processed, the out-of-phase condition of these two sound waves may result in destructive interference. Under this circumstance, the performance of the speaker 10 is deteriorated. For solving this problem, when the backwardly-radiated sound wave reflected by the backside plate of the enclosure 12 is guided to the opening 13 of the enclosure 12 through the sound guide tube 14, the phase of the backwardly-radiated sound wave is inverted. The inverted phase of the backwardly-radiated sound wave is identical to the phase of the forwardly-radiated sound wave. The backwardly-radiated sound wave with the inverted phase and the forwardly-radiated sound wave are superimposed with each other to result in constructive interference. Under this circumstance, the low-frequency radiation intensity of the open-type speaker 10 is increased. The structure and the operating principle of the open-type speaker 10 are similar to those of the general open-type speaker with the bass reflex enclosure, and are not redundantly described herein.

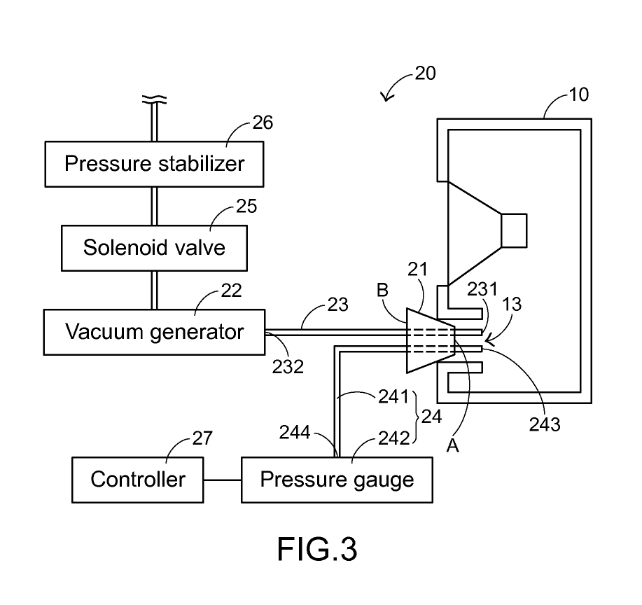

FIG. 3 schematically illustrates the architecture of an open-type speaker leak test system according to an embodiment of the present invention. As shown in FIG. 3, the open-type speaker leak test system 20 comprises a sealing element 21, a vacuum generator 22, a first communication tube 23, a pressure measuring module 24, a solenoid valve 25, a pressure stabilizer 26, and a controller 27.

The sealing element 21 is locked into the opening 13 of the open-type speaker 10 for sealing the opening 13, so that the inner space of the enclosure 12 becomes a sealed space. The sealing element 21 is made of an elastic material. An example of the elastic material includes but is not limited to a rubbery material, a cork material or a plastic material. In this embodiment, the sealing element 21 is a cork stopper, but is not limited thereto. Moreover, the cork stopper 21 comprises a first end A and a second end B. The first end A of the cork stopper 21 is penetrated through the opening 13 and inserted into the inner space of the open-type speaker 10. The second end B of the cork stopper 21 is located outside the open-type speaker 10.

In case that there is a seam between the cork stopper 21 and the opening 13, the opening 13 cannot be sealed by the cork stopper 21 successfully, and the inner space of the open-type speaker 10 cannot be the sealed space. For creating the sealed space, it is preferred that the opening 13 of the open-type speaker 10 is a circular opening and the cork stopper 21 is a cone-shaped structure corresponding to the opening 13. Moreover, the diameter of the first end A of the cork stopper 21 is smaller than the diameter of the opening 13; and the diameter of the second end B of the cork stopper 21 is larger than the diameter of the opening 13. Consequently, the tightness of the cork stopper 21 locked in the opening 13 is increased.

By using the flow of the compressed air, the vacuum generator 22 creates a vacuum. Since the air within the enclosure 12 is extracted out by the vacuum generator 22, a negative pressure in the inner space of the enclosure 12 is generated by the vacuum generator 22. In an embodiment, after the vacuum generator 22 extracts the air of a qualified enclosure for a predetermined time period (e.g. 5 seconds), the value of negative pressure within the qualified enclosure is defined as a default negative pressure value. It is noted that the open-type speaker leak test system is not restricted to generate the negative pressure. Alternatively, in another embodiment of the open-type speaker leak test system, a positive pressure generation device may be used to generate a positive pressure in inner space of the enclosure. According to the positive pressure value, the open-type speaker leak test system may test whether there is a leak.

The first communication tube 23 is in communication with the open-type speaker 10 and the vacuum generator 22. A first end 231 of the first communication tube 23 is penetrated through the sealing element 21 and inserted into the enclosure 12 of the open-type speaker 10. A second end 232 of the first communication tube 23 is connected with the vacuum generator 22.

The components and installations of the pressure measuring module 24 will be illustrated as follows. The pressure measuring module 24 comprises a second communication tube 241 and a pressure gauge 242. The open-type speaker 10 and the second communication tube 241 are in communication with the pressure gauge 242. A first end 243 of the second communication tube 241 is penetrated through the sealing element 21 and inserted into the enclosure 12 of the open-type speaker 10. A second end 244 of the second communication tube 241 is connected with the pressure gauge 242 and located outside the enclosure 12. For example, the pressure gauge 242 is a general barometer for measuring an equilibrium pressure value of the enclosure 12. After the air in the enclosure 12 is extracted by the vacuum generator 22, the air pressure of the enclosure 12 and the air pressure of the first communication tube 23 are gradually in the equilibrium state. Consequently, the inner space of the enclosure 12 has the equilibrium pressure value. Under this circumstance, the equilibrium pressure value of the enclosure 12 can be directly measured by the pressure gauge 242 through the second communication tube 241. Since the influence of the airflow generated during the process of extracting the air by the vacuum generator 22 is minimized, the measured pressure value is more accurate.

In this embodiment, the controller 27 is electrically connected with the pressure gauge 242. The equilibrium pressure value that is measured by the pressure gauge 242 is transmitted to the controller 27. If the equilibrium pressure value is equal to the default negative pressure value, which is the negative pressure generated by the vacuum generator 22 and corresponding to the qualified enclosure, the controller 27 judges that the open-type speaker 10 has no leak. On the other hand, if the absolute value of the equilibrium pressure value is lower than the absolute value of the default negative pressure value, which is the negative pressure generated by the vacuum generator 22 and corresponding to the qualified enclosure, the controller 27 judges that the open-type speaker 10 has a leak.

Moreover, the open-type speaker leak test system 20 is further equipped with the solenoid valve 25 and the pressure stabilizer 26. During the process of testing the open-type speaker 10, the solenoid valve 25 and the pressure stabilizer 26 can control whether the air flows in the first communication tube 23, and can control the airflow in the first communication tube 23 in order to stabilize the air pressure of the first communication tube 23. The solenoid valve 25 and the pressure stabilizer 25 are located at an end of the vacuum generator 22, but are not limited thereto. The solenoid valve 25 is used to control whether the air flows in the first communication tube 23. After the vacuum generator 22 extracts the air from the enclosure 12 for the predetermined time period, the solenoid valve 25 is turned off. Consequently, the vacuum generator 22 no longer extracts the air from the enclosure 12. The pressure stabilizer 26 is used for stabilizing the air pressure of the first communication tube 23. Since the fluctuation amount of the air pressure in the first communication tube 23 is not too large, the read value of the pressure gauge 242 can be easily read. Moreover, for accelerating the testing task, the open-type speaker leak test system is preferably automated. Under this circumstance, the solenoid valve 25 and the pressure stabilizer 26 are electrically connected with the controller 27 and controlled by the controller 27, but are not limited thereto.

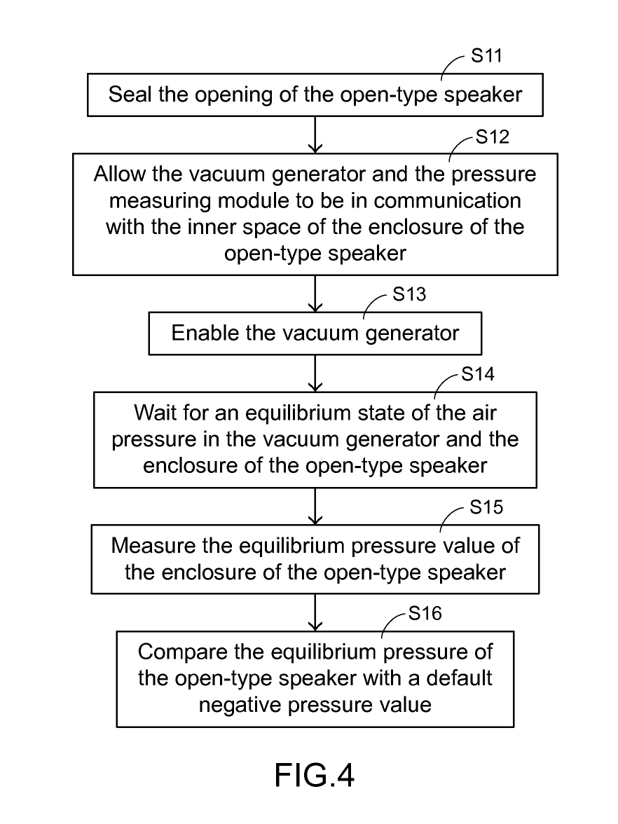

Hereinafter, an open-type speaker leak test method according to an embodiment of the present invention will be illustrated with reference to FIG. 4. FIG. 4 schematically illustrates the flowchart of an open-type speaker leak test method according to an embodiment of the present invention. As shown in FIG. 4, the open-type speaker leak test method comprises the steps S11˜S16.

Firstly, in the step S11, the opening 13 of the open-type speaker 10 is sealed by the sealing element 21, so that an inner space of the enclosure 12 is a sealed space.

In the step S12, the vacuum generator 22 and the pressure measuring module 24 are in communication with the inner space of the enclosure 12 of the open-type speaker 10. As mentioned above, first communication tube 23 is in communication with the vacuum generator 22 and the enclosure 12, and the second communication tube 241 is in communication with the pressure gauge 242 of the pressure measuring module 24 and the enclosure 12.

Then, in the step S13, the vacuum generator 22 is enabled to extract air from the enclosure 12, so that a negative pressure value of the inner space of the enclosure 12 is generated.

Then, the step S14 is performed to wait for an equilibrium state of the air pressure in the vacuum generator 22 and the enclosure 12 of the open-type speaker 10.

When the air pressure reaches the equilibrium state, the equilibrium pressure value of the enclosure 12 of the open-type speaker 10 is measured (Step S15).

Then, the step S16 is performed to judge whether the open-type speaker 10 has the leak according to a result of comparing the equilibrium pressure value of the open-type speaker 10 with a default negative pressure value, wherein the default negative pressure value is a negative pressure generated by the vacuum generator 22 when a qualified enclosure is tested. If the equilibrium pressure value is equal to the default negative pressure value, the controller 27 judges that the open-type speaker 10 has no leak. On the other hand, if the absolute value of the equilibrium pressure value is lower than the absolute value of the default negative pressure value, the controller 27 judges that the open-type speaker 10 has a leak.

In this embodiment, the step of comparing the equilibrium pressure value with the default negative pressure value is performed by the controller 27, which is electrically connected with the pressure gauge 242. It is noted that the step of comparing the equilibrium pressure value with the default negative pressure value is not restricted to be performed by the controller. For example, in some other embodiments, the step of comparing the equilibrium pressure value with the default negative pressure value generated by the vacuum generator may be performed by an inspector.

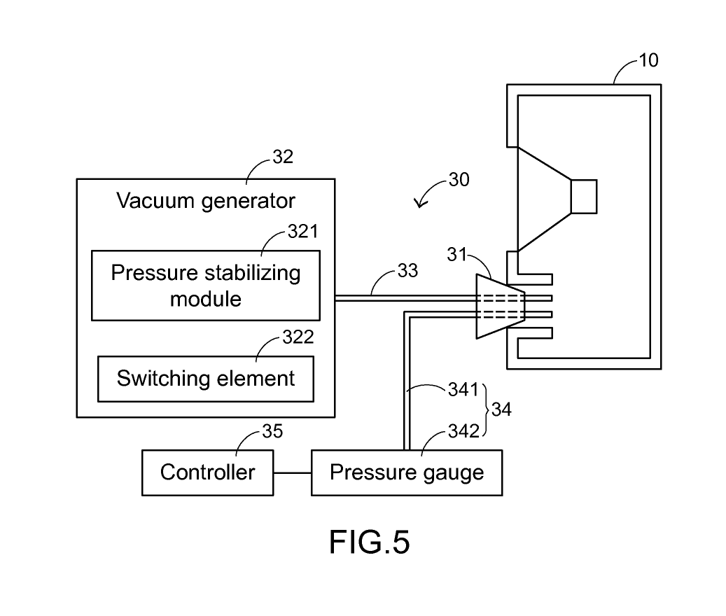

Hereinafter, an open-type speaker leak test system according to another embodiment of the present invention will be illustrated with reference to FIG. 5. FIG. 5 schematically illustrates the architecture of an open-type speaker leak test system according to another embodiment of the present invention. The open-type speaker leak test system 30 of FIG. 5 is used to test the open-type speaker 10. As shown in FIG. 5, the open-type speaker leak test system 30 comprises a sealing element 31, a vacuum generator 32, a first communication tube 33, a pressure measuring module 34, and a controller 35. The pressure measuring module 34 comprises a second communication tube 341 and a pressure gauge 342.

In comparison with the open-type speaker leak test system 20 of FIG. 3, the vacuum generator 32 of the open-type speaker leak test system 30 of this embodiment comprises a pressure stabilizing module 321 and a switching element 322. The other components of the open-type speaker leak test system 30 of FIG. 5 are similar to those of the open-type speaker leak test system 20 of FIG. 3, and are not redundantly described herein.

The pressure stabilizing module 321 and the switching element 322 are used for replacing the pressure stabilizer 26 and the solenoid valve 25 of the open-type speaker leak test system 20 of FIG. 3, respectively. The air pressure of the first communication tube 33 is stabilized by the pressure stabilizing module 321. The switching element 322 is used to control whether the air in the first communication tube 33 flows. In other words, the airflow in the first communication tube 33 of the open-type speaker leak test system 30 can be stabilized or controlled without the additional uses of the pressure stabilizer 26 and the solenoid valve 25. The operations of the open-type speaker leak test system 30 are similar to those of the open-type speaker leak test system 20 of FIG. 3, and are not redundantly described herein.

From the above descriptions, the present invention provides the open-type speaker leak test system and the open-type speaker leak test method. By the vacuum generator, the enclosure of the open-type speaker has a negative pressure value. By the pressure measuring module, the equilibrium pressure value of the enclosure is measured. According to a result of comparing the equilibrium pressure value of the open-type speaker with the default negative pressure value, the open-type speaker leak test system judges whether the open-type speaker has a leak, wherein the default negative pressure value is a negative pressure generated by the vacuum generator when a qualified enclosure is tested. In comparison with the conventional leak test method using the stethoscope, the open-type speaker leak test method of the present invention using the pressure measuring module can reduce the possibility of causing human misjudgment and increase the efficiency of testing the leak of the open-type speaker. Moreover, since the equilibrium pressure value of the inner space of the enclosure is directly measured by the pressure measuring module, the airflow caused by the vacuum generator has less influence on the pressure measuring module. Consequently, the accuracy of measuring the equilibrium pressure value of the inner space of the enclosure will be enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An open-type speaker leak test system for testing whether an open-type speaker has a leak, the open-type speaker comprising an enclosure with an opening, the open-type speaker leak test system comprising:
a sealing element, wherein when the sealing element is locked into the opening, the opening is sealed;
a vacuum generator, wherein a negative pressure value of the enclosure is generated by the vacuum generator;
a first communication tube in communication with the open-type speaker and the vacuum generator, wherein a first end of the first communication tube is penetrated through the sealing element and inserted into the enclosure of the open-type speaker, and a second end of the first communication tube is connected with the vacuum generator; and
a pressure measuring module, wherein an equilibrium pressure value of the enclosure of the open-type speaker is measured by the pressure measuring module,
wherein according to a result of comparing the equilibrium pressure value of the open-type speaker with a default negative pressure value, the open-type speaker leak test system judges whether the open-type speaker has the leak, wherein the default negative pressure value is the negative pressure value generated by the vacuum generator when a qualified enclosure is tested.

2. The open-type speaker leak test system according to claim 1, wherein the pressure measuring module comprises a second communication tube and a pressure gauge, wherein a first end of the second communication tube is penetrated through the sealing element and inserted into the enclosure, and a second end of the second communication tube is connected with the pressure gauge and located outside the enclosure.

3. The open-type speaker leak test system according to claim 2, further comprises a controller, wherein the controller is electrically connected with the pressure gauge, and the equilibrium pressure value measured by the pressure gauge is transmitted to the controller, wherein if the equilibrium pressure value is equal to the default negative pressure value, the controller judges that the open-type speaker has no leak, wherein if an absolute value of the equilibrium pressure value is lower than an absolute value of the default negative pressure value, the controller judges that the open-type speaker has the leak.

4. The open-type speaker leak test system according to claim 1, wherein the sealing element is made of an elastic material.

5. The open-type speaker leak test system according to claim 1, further comprising a solenoid valve, wherein the solenoid valve is installed on the first communication tube and controls whether an air flows in the first communication tube.

6. The open-type speaker leak test system according to claim 1, further comprising a pressure stabilizer, wherein the pressure stabilizer is installed on the first communication tube, and an air pressure of the first communication tube is stabilized by the pressure stabilizer.

7. The open-type speaker leak test system according to claim 1, wherein the vacuum generator comprises a pressure stabilizing module and a switching element, wherein an air pressure of the first communication tube is stabilized by the pressure stabilizing module, and the switching element controls whether an air flows in the first communication tube.

8. The open-type speaker leak test system according to claim 1, wherein the open-type speaker further comprises a sound guide tube and a speaker unit, wherein the speaker unit is embedded in the enclosure, the sound guide tube is disposed within the enclosure, and an end of the sound guide tube is connected with the opening.

9. An open-type speaker leak test method for testing whether an open-type speaker has a leak, the open-type speaker comprising an enclosure with an opening, the open-type speaker leak test method comprising steps of:
sealing the opening of the open-type speaker;
allowing a vacuum generator and a pressure measuring module to be in communication with an inner space of the enclosure of the open-type speaker;
enabling the vacuum generator, so that a negative pressure value of the enclosure is generated;
waiting for an equilibrium state of an air pressure in the vacuum generator and the enclosure of the open-type speaker;
measuring an equilibrium pressure value of the enclosure of the open-type speaker; and
judging whether the open-type speaker has the leak according to a result of comparing the equilibrium pressure value of the open-type speaker with a default negative pressure value, wherein the default negative pressure value is the negative pressure value generated by the vacuum generator when a qualified enclosure is tested.

10. The open-type speaker leak test method according to claim 9, wherein the opening of the open-type speaker is sealed by locking a sealing element into the opening.

11. The open-type speaker leak test method according to claim 9, wherein the vacuum generator and the pressure measuring module are in communication with the inner space of the enclosure of the open-type speaker through a first communication tube, wherein a first end of the first communication tube is penetrated through the opening and inserted into the enclosure of the open-type speaker, and a second end of the first communication tube is connected with the vacuum generator.

12. The open-type speaker leak test method according to claim 9, wherein the pressure measuring module comprises a second communication tube and a pressure gauge, wherein a first end of the second communication tube is penetrated through the opening and inserted into the enclosure, and a second end of the second communication tube is connected with the pressure gauge and located outside the enclosure.
